(19) United States
(12) Patent Application Publication
(10) Pub. No.: US 2017/0371614 A1
(43) Pub. Date: Dec. 28, 2017

(54) METHOD, APPARATUS, AND STORAGE MEDIUM

(71) Applicant: FUJITSU LIMITED, Kawasaki-shi (JP)

(72) Inventors: Ryo Miyamoto, Kawasaki (JP); Koichi Yamasaki, Kawasaki (JP); Tomoharu Imai, Kawasaki (JP); Kazuki Matsui, Kawasaki (JP)

(73) Assignee: FUJITSU LIMITED, Kawasaki-shi (JP)

(21) Appl. No.: 15/485,663

(22) Filed: Apr. 12, 2017

(30) Foreign Application Priority Data
Jun. 24, 2016 (JP) 2016-125879

(51) Int. Cl. G06F 3/14; G09G 5/00; H04L 29/06

(52) U.S. Cl. CPC G06F 3/1462; G09G 5/005; G09G 2360/127; H04L 67/42; G09G 2370/022

(57) ABSTRACT

A method includes: transmitting a screen shared by a plurality of apparatuses coupled through a network to the plurality of apparatuses at a given interval; updating the screen based on operation information when receiving the operation information regarding the screen from a first apparatus which an operation right regarding the screen is given among the plurality of apparatuses; and determining, by a processor, the given interval based on comparison between a first index value that represents smoothness of display of the screen in the first apparatus and a second index value that represents smoothness of display of the screen in a second apparatus among the plurality of apparatuses when the operation right is moved from the first apparatus to the second apparatus.

### CROSS-REFERENCE TO RELATED APPLICATION

This application is based upon and claims the benefit of priority of the prior Japanese Patent Application No. 2016-125879, filed on Jun. 24, 2016, the entire contents of which are incorporated herein by reference.

### FIELD

The embodiments discussed herein are related to a method, an apparatus, and a storage medium.

### BACKGROUND

In recent years, the virtual desktop infrastructure (VDI) has been becoming popular in terms of the business continuity plan (BCP), security, and so forth. The virtual desktop infrastructure is a system in which a virtual desktop environment is constructed in a virtual machine (VM) on a virtualized server and this desktop environment is made usable from a thin client terminal or the like via a network or the like. The virtual machine is a virtual calculator to which resources such as a central processing unit (CPU) and a memory possessed by the server are allocated in a divided manner. A technique to implement the virtual machine is called a virtualization technology. The thin client is a system to enable the virtual desktop environment implemented by utilizing the processing capability of the server to be used via a network.

Until now, the virtual desktop infrastructure has been used for simple clerical work in many cases. However, in recent years, needs for the virtual desktop have been increasing also for work in which a high-definition computer aided design (CAD) application or video is treated. In this case, there are also needs to share the same screen among plural terminals and make collaboration in order to make efficient communication at the time of development and design. For example, regarding highly-confidential design data such as CAD data, there are also needs to make collaboration among remote places, with the data stored in an environment in which security is ensured, such as a data center. The virtual desktop infrastructure is suitable for such needs.

As examples of the related art, Japanese Laid-open Patent Publication No. 11-331199, Japanese Laid-open Patent Publication No. 2001-14253, and Japanese Laid-open Patent Publication No. 9-198227 are available.

### SUMMARY

According to an aspect of the embodiments, a method includes: transmitting a screen shared by a plurality of apparatuses coupled through a network to the plurality of apparatuses at a given interval; updating the screen based on operation information when receiving the operation information regarding the screen from a first apparatus which an operation right regarding the screen is given among the plurality of apparatuses; and determining, by a processor, the given interval based on comparison between a first index value that represents smoothness of display of the screen in the first apparatus and a second index value that represents smoothness of display of the screen in a second apparatus among the plurality of apparatuses when the operation right is moved from the first apparatus to the second apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a virtual desktop infrastructure in a first embodiment;

FIG. 2 illustrates a hardware configuration example of a server device in the first embodiment;

FIG. 3 illustrates a functional configuration example of a virtual desktop infrastructure in the first embodiment;

FIG. 4 is a flowchart for explaining one example of a processing procedure carried out by a server device in response to reception of an operation event in the first embodiment;

FIG. 5 is a flowchart for explaining one example of a processing procedure carried out by a server device at the time of transmission of updated image information in the first embodiment;

FIG. 6 is a flowchart for explaining one example of a processing procedure carried out by a server device at the time of movement of an operation right in the first embodiment;

FIG. 7 is a flowchart for explaining one example of a processing procedure carried out by a client terminal in response to reception of updated image information in the first embodiment;

FIG. 8 illustrates a configuration example of an image information storing unit;

FIG. 9 illustrates a configuration example of a usable bandwidth storing unit;

FIG. 10 illustrates a configuration example of a processing capability storing unit;

FIG. 11 illustrates a configuration example of a rendering frame rate storing unit;

FIG. 12 is a flowchart for explaining one example of a processing procedure carried out by a client terminal at the time of transmission of an operation right request in the first embodiment;

FIG. 13 is a diagram for explaining one example of the first embodiment;

FIG. 14 illustrates a reception timing of updated image information and so forth in each client terminal in the case in which a rendering frame rate of a movement destination of an operation right is employed as a transmission frame rate;

FIG. 15 illustrates a reception timing of updated image information and so forth in each client terminal in the case in which the first embodiment is applied;

FIG. 16 illustrates a functional configuration example of a virtual desktop infrastructure in a second embodiment;

FIG. 17 is a flowchart for explaining one example of a processing procedure carried out by a server device at the time of movement of an operation right in the second embodiment;

FIG. 18 illustrates a functional configuration example of a virtual desktop infrastructure in a third embodiment; and

FIG. 19 is a flowchart for explaining one example of a processing procedure carried out by a server device at the time of movement of an operation right in the third embodiment.

### DESCRIPTION OF EMBODIMENTS

If a screen of a virtual desktop is shared among plural terminals, it is preferable to adjust the frame rate relating to transmission of screen information from the server to the terminals (transmission interval of screen information) because there is a possibility that the communication environment (bandwidth of a network) and the image rendering performance differ on each terminal basis. However, transmitting the screen information at frame rates different for each terminal might increase the processing load on the server side. On the other hand, with a fixed frame rate set in common to all terminals, the communication environment and the performance of the terminals might not be sufficiently used.

In the embodiments discussed herein, a screen is transmitted at a transmission interval according to the status of plural terminals that share the screen via a network.

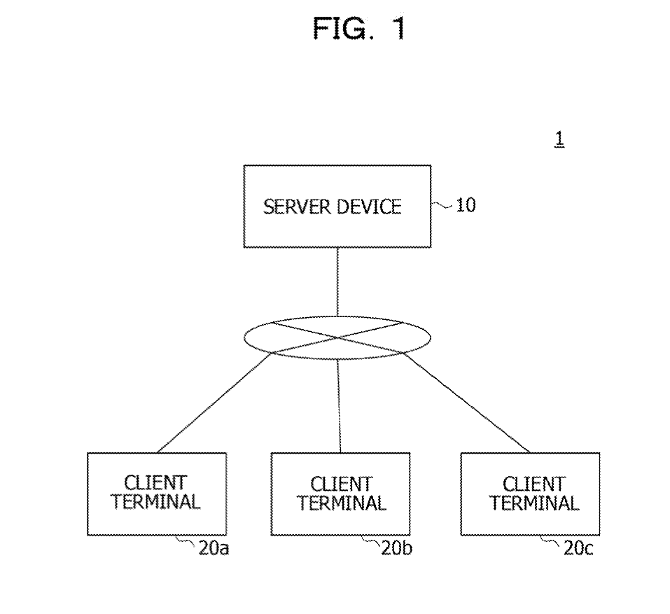

The embodiments will be described below based on the drawings. FIG. 1 illustrates a configuration example of a virtual desktop infrastructure in a first embodiment. In FIG. 1, a virtual desktop infrastructure 1 includes a server device 10 and plural client terminals 20 such as a client terminal 20a, a client terminal 20b, and a client terminal 20c. The server device 10 and the respective client terminals 20 are coupled through a network such as the Internet or a local area network (LAN).

The server device 10 is a computer that constructs a virtual desktop and executes processing for enabling this virtual desktop to be used from each client terminal 20 via the network.

The client terminal 20 is a terminal that functions as a user interface to the virtual desktop. The plural client terminals 20 share a screen of the same virtual desktop. A personal computer (PC), a tablet terminal, a smartphone, or the like may be used as the client terminal 20.

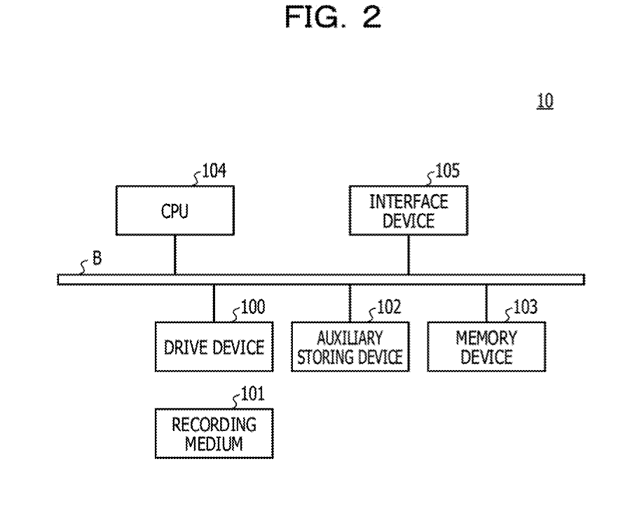

FIG. 2 illustrates a hardware configuration example of the server device in the first embodiment. The server device 10 of FIG. 2 includes a drive device 100, an auxiliary storing device 102, a memory device 103, a CPU 104, an interface device 105, and so forth that are each mutually coupled by a bus B.

A program to implement processing in the server device 10 is provided by a recording medium 101. When the recording medium 101 in which the program is recorded is set in the drive device 100, the program is installed on the auxiliary storing device 102 from the recording medium 101 via the drive device 100. The installation of the program does not have to be carried out from the recording medium 101 and may be carried out by being downloaded from another computer via the network. The auxiliary storing device 102 stores the installed program and stores files, data, and so forth.

When an instruction to activate the program is made, the memory device 103 stores the program read out from the auxiliary storing device 102. The CPU 104 executes functions relating to the server device 10 in accordance with the program stored in the memory device 103. The interface device 105 is used as an interface for coupling to the network.

As one example of the recording medium 101, a portable recording medium such as a compact disc read only memory (CD-ROM), a digital versatile disc (DVD) disc, or a universal serial bus (USB) memory is cited. Furthermore, as one example of the auxiliary storing device 102, a hard disk drive (HDD) or a flash memory or the like is cited. Both of the recording medium 101 and the auxiliary storing device 102 are equivalent to a computer-readable recording medium.

Each client terminal 20 may also include the hardware configuration illustrated in FIG. 2.

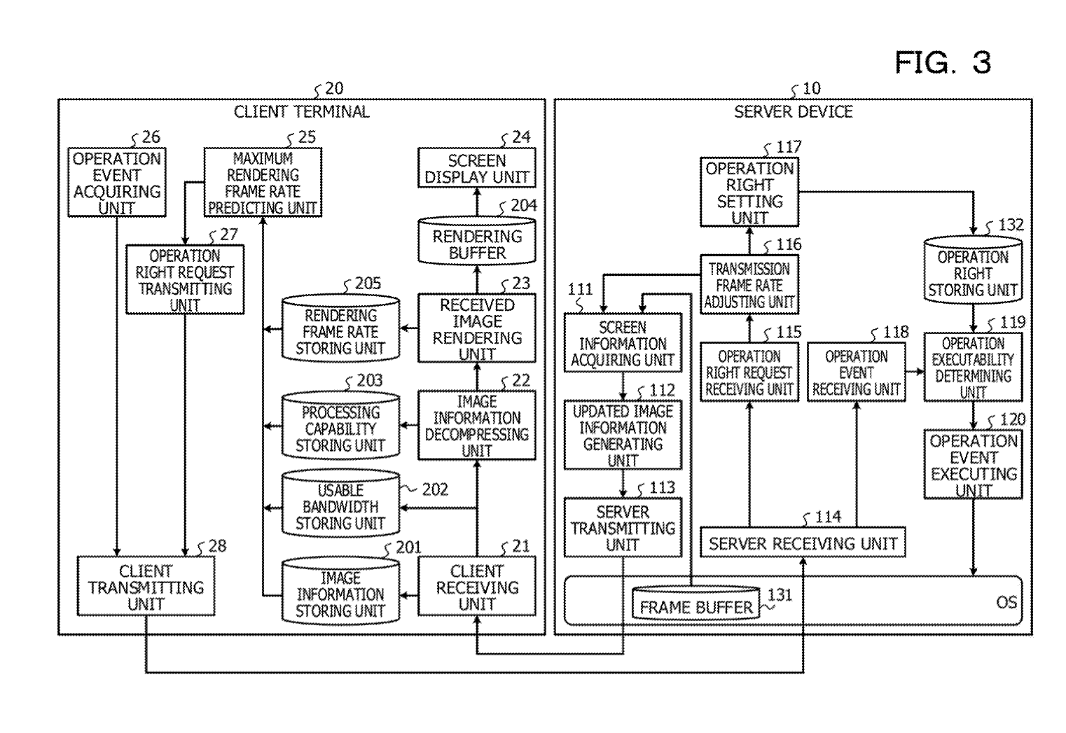

FIG. 3 illustrates a functional configuration example of the virtual desktop infrastructure in the first embodiment. In FIG. 3, the client terminal 20 includes a client receiving unit 21, an image information decompressing unit 22, a received image rendering unit 23, a screen display unit 24, a maximum rendering frame rate predicting unit 25, an operation event acquiring unit 26, an operation right request transmitting unit 27, a client transmitting unit 28, and so forth. These respective units are implemented by execution of one or more programs installed on the client terminal 20 by a CPU of the client terminal 20. Furthermore, the client terminal 20 uses an image information storing unit 201, a usable bandwidth storing unit 202, a processing capability storing unit 203, a rendering buffer 204, a rendering frame rate storing unit 205, and so forth. These respective storing units are implemented by using an auxiliary storing device or a memory device or the like in the client terminal 20, for example.

The client receiving unit 21 receives updated image information that is image information of an updated region of a virtual desktop screen from the server device 10. The updated region refers to a region updated for the virtual desktop screen that is currently displayed. The client receiving unit 21 stores the data amount [byte] of the updated image information, the area [pixel²] of the updated region relating to the updated image information, and so forth in the image information storing unit 201. Furthermore, the client receiving unit 21 estimates the bandwidth that can be used (hereinafter, referred to as “usable bandwidth”) at the present time regarding communications with the server device 10 based on the time taken to receive the updated image information and so forth, and stores the estimation result in the usable bandwidth storing unit 202. It suffices that a publicly-known technique be used for the estimation of the usable bandwidth.

The image information decompressing unit 22 decompresses the updated image information received by the client receiving unit 21. The decompression refers to extracting or restoring updated image information compressed by coding. Furthermore, the image information decompressing unit 22 stores the processing time taken to execute the decompression processing in the processing capability storing unit 203.

The received image rendering unit 23 writes the updated image information decompressed by the image information decompressing unit 22 to the rendering buffer 204. Furthermore, the received image rendering unit 23 calculates the number of pieces of updated image information rendered per unit time (hereinafter, referred to as “rendering frame rate”) based on the difference in the clock time of writing to the rendering buffer 204 between the previous and present frames (updated image information). The calculation result is stored in the rendering frame rate storing unit 205.

The screen display unit 24 displays the contents of the rendering buffer 204 on a display device of the client terminal 20.

The maximum rendering frame rate predicting unit 25 calculates the maximum rendering frame rate based on the values stored in the image information storing unit 201, the value stored in the processing capability storing unit 203, and the usable bandwidth stored in the usable bandwidth storing unit 202. The maximum rendering frame rate refers to the predicted value of the upper limit of the number of frames that can be rendered by the client terminal 20 per unit time. The maximum rendering frame rate is one example of an index value that represents (upper limit of) smoothness of display of the virtual desktop screen in the client terminal 20.

The operation event acquiring unit 26 acquires an operation event from an input device such as a keyboard, a mouse, or a touch panel coupled to the client terminal 20.

The operation right request transmitting unit 27 transmits a request for obtainment of the operation right (hereinafter, referred to as “operation right request”) to the server device 10 in response to an instruction to attain the operation right, input by a user through the input device. The operation right refers to a right to carry out operation of the virtual desktop screen. In the present embodiment, only operation by the client terminal 20 given the operation right is valid. Note that in the operation right request, the maximum rendering frame rate calculated by the maximum rendering frame rate predicting unit 25 is included.

The client transmitting unit 28 transmits an operation event (operation information) acquired by the operation event acquiring unit 26, an operation right request, and so forth to the server device 10.

Meanwhile, the server device 10 includes a screen information acquiring unit 111, an updated image information generating unit 112, a server transmitting unit 113, a server receiving unit 114, an operation right request receiving unit 115, a transmission frame rate adjusting unit 116, an operation right setting unit 117, an operation event receiving unit 118, an operation executability determining unit 119, an operation event executing unit 120, and so forth. These respective units are implemented by execution of one or more programs installed on the server device 10 by the CPU 104. Furthermore, the server device 10 uses a frame buffer 131, an operation right storing unit 132, and so forth. These respective storing units are implemented by using the memory device 103 or the auxiliary storing device 102 or the like, for example.

The screen information acquiring unit 111 acquires display information of the virtual desktop screen (hereinafter, referred to as “screen display information”) that is managed by an operating system (OS) of the server device 10 and is stored in the frame buffer 131 at a time interval based on a transmission frame rate set from the transmission frame rate adjusting unit 116. The screen display information is image information that represents the contents of display of the whole virtual desktop screen.

The updated image information generating unit 112 extracts image information of an updated region (updated image information) from the screen display information acquired by the screen information acquiring unit 111 and compresses this updated image information.

The server transmitting unit 113 transmits the updated image information generated by the updated image information generating unit 112 to the client terminal 20.

The server receiving unit 114 receives an operation event and an operation right request from the client terminal 20.

If information received by the server receiving unit 114 is an operation right request, the operation right request receiving unit 115 acquires this operation right request from this received information.

The transmission frame rate adjusting unit 116 decides the transmission frame rate based on comparison between the maximum rendering frame rate of the client terminal 20 of the movement origin of the operation right (including the operation right) and the maximum rendering frame rate of the client terminal 20 of the movement destination of the operation right, included in the operation right request. The transmission frame rate adjusting unit 116 sets the decided transmission frame rate in the screen information acquiring unit 111.

The operation right setting unit 117 stores identification information (hereinafter, referred to as “terminal identification (ID)”) of the client terminal 20 of the movement destination of the operation right in the operation right storing unit 132. Note that the internet protocol (IP) address may be used as the terminal ID.

If information received by the server receiving unit 114 is an operation event, the operation event receiving unit 118 acquires this operation event from this received information.

The operation executability determining unit 119 determines whether or not execution of the operation event is possible according to the transmission source of the operation event received by the operation event receiving unit 118. For example, if the transmission source of the operation event is the client terminal 20 including the operation right, the operation executability determining unit 119 determines that this operation event can be executed. If not so, the operation executability determining unit 119 determines not to execute this operation event.

The operation event executing unit 120 transfers the operation event determined to be executable to the OS and causes the OS to execute processing according to this operation event.

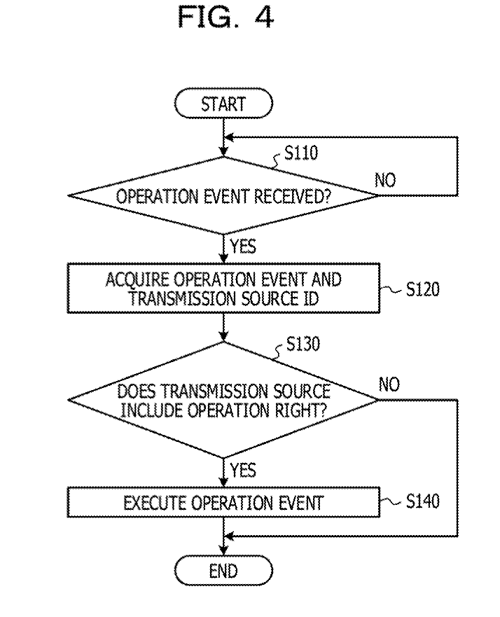

Processing procedures carried out by each of the server device 10 and the client terminal 20 will be described below. FIG. 4 is a flowchart for explaining one example of a processing procedure carried out by the server device in response to reception of an operation event in the first embodiment.

When an operation event to the virtual desktop screen, generated in the client terminal 20, is received by the server receiving unit 114 (S110; YES), the operation event receiving unit 118 acquires this operation event and the terminal ID of the client terminal 20 of the transmission source of this operation event (hereinafter, referred to as “transmission source ID”) from the information received by the server receiving unit 114 (S120).

Subsequently, the operation executability determining unit 119 determines whether or not the client terminal 20 of the transmission source of the operation event includes the operation right (S130). For example, if the transmission source ID corresponds with the terminal ID stored in the operation right storing unit 132, it is determined that the client terminal 20 of the transmission source of the operation event includes the operation right. If not so, it is determined that the client terminal 20 of the transmission source of the operation event does not include the operation right.

If the client terminal 20 of the transmission source of the operation event does not include the operation right (S130; NO), the operation executability determining unit 119 discards this operation event. If the client terminal 20 of the transmission source of the operation event includes the operation right (S130; YES), the operation event executing unit 120 causes the OS to execute this operation event (S140). As a result, the operation result relating to this operation event is reflected in the screen display information of the virtual desktop screen stored in the frame buffer 131. For example, this screen display information changes according to the operation event.

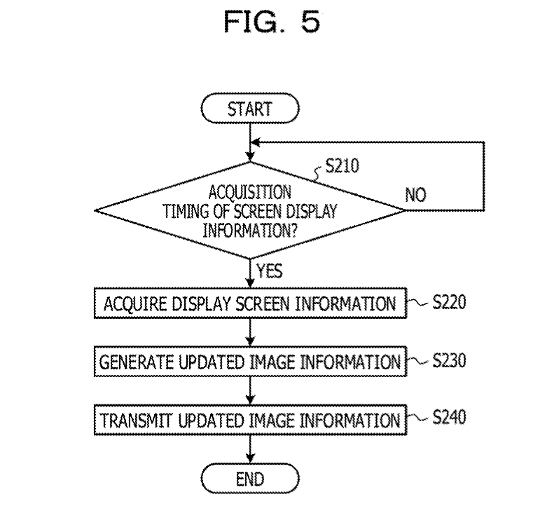

FIG. 5 is a flowchart for explaining one example of a processing procedure carried out by the server device at the time of transmission of updated image information in the first embodiment.

In a step S210, the screen information acquiring unit 111 determines whether or not the present timing is acquisition timing of the screen display information. This acquisition timing is determined based on the transmission frame rate set by the transmission frame rate adjusting unit 116. For example, it is determined whether or not the time interval based on the transmission frame rate has elapsed from the previous (last) acquisition timing of the screen display information.

When the acquisition timing of the screen display information has come (S210; YES), the screen information acquiring unit 111 acquires the screen display information of the virtual desktop screen from the frame buffer 131 (S220).

Subsequently, the updated image information generating unit 112 generates updated image information relating to the region of difference between the screen display information acquired this time and the screen display information acquired at the previous time, and compresses this updated image information (S230). Subsequently, the server transmitting unit 113 transmits this updated image information to each client terminal 20 (S240). For example, the updated image information is transmitted to the respective client terminals 20 at once at the same time interval.

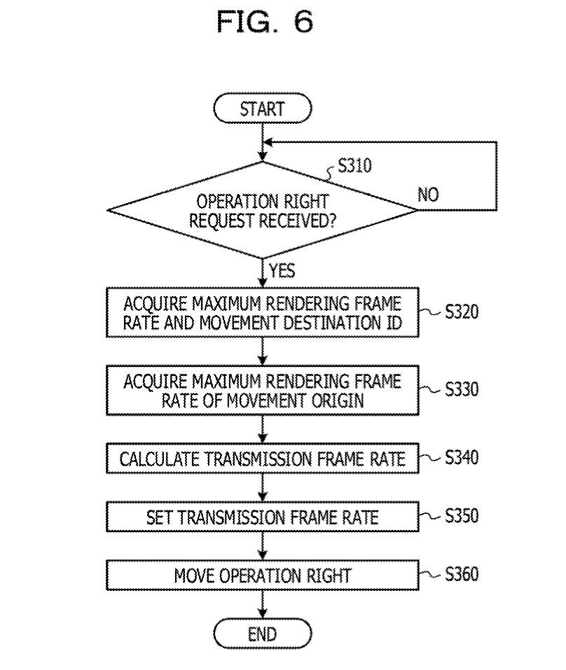

FIG. 6 is a flowchart for explaining one example of a processing procedure carried out by the server device at the time of movement of the operation right in the first embodiment.

When an operation right request is received by the server receiving unit 114 (S310; YES), the operation right request receiving unit 115 acquires the maximum rendering frame rate included in this operation right request and the terminal ID (hereinafter, referred to as “movement destination ID”) of the client terminal 20 of the transmission source of this operation right request (hereinafter, referred to as “movement destination client terminal 20”) from the information received by the server receiving unit 114 (S320).

Subsequently, the transmission frame rate adjusting unit 116 acquires the maximum rendering frame rate of the client terminal 20 including the operation right at the present time from this client terminal 20 (hereinafter, referred to as “movement origin client terminal 20”) (S330). The movement origin client terminal 20 can be identified through reference to the operation right storing unit 132.

Subsequently, the transmission frame rate adjusting unit 116 calculates the transmission frame rate based on the magnitude relationship between the maximum rendering frame rate of the movement origin client terminal 20 and the maximum rendering frame rate of the movement destination client terminal 20 (S340). For example, if the maximum rendering frame rate of the movement destination is lower (if smoothness of display is lower in the movement destination), the transmission frame rate adjusting unit 116 employs the maximum rendering frame rate of the movement destination+1 as the new transmission frame rate. For example, the transmission frame rate is so decided that the smoothness of display becomes higher than in the movement destination. On the other hand, if the maximum rendering frame rate of the movement destination is higher (if smoothness of display is higher in the movement destination), the transmission frame rate adjusting unit 116 employs the maximum rendering frame rate of the movement destination×0.7 as the new transmission frame rate. For example, the transmission frame rate is so decided that the smoothness of display becomes lower than in the movement destination.

Due to the decision of the transmission frame rate in this manner, the change in the transmission frame rate in association with the movement of the operation right becomes gentle. For example, change in the smoothness of update of the screen on the virtual desktop in association with the movement of the operation right becomes gentle.

The values “+1” and “0.7” in the maximum rendering frame rate of the movement destination+1 and the maximum rendering frame rate of the movement destination×0.7 are merely one example. Furthermore, the transmission frame rate may be calculated by another method as long as the method is a calculation method with the same intent.

Subsequently, the transmission frame rate adjusting unit 116 sets the calculated transmission frame rate in the screen information acquiring unit 111 (S350). As a result, the transmission frame rate from the server device 10 to the client terminal 20 is updated.

Subsequently, the operation right setting unit 117 moves the operation right (S360). For example, the operation right setting unit 117 stores the movement destination ID in the operation right storing unit 132. At this time, the movement origin ID stored in the operation right storing unit 132 is overwritten by the movement destination ID.

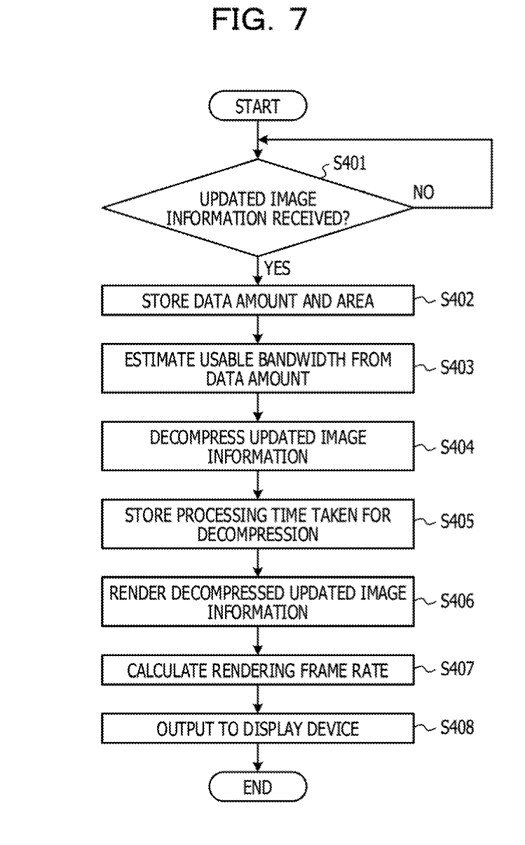

Next, processing executed by the client terminal 20 will be described. FIG. 7 is a flowchart for explaining one example of a processing procedure carried out by the client terminal in response to reception of updated image information in the first embodiment.

When receiving updated image information transmitted from the server device 10 (S401; YES), the client receiving unit 21 causes the data amount of this updated image information and the area of the updated region relating to this updated image information to be stored in the image information storing unit 201 (S402).

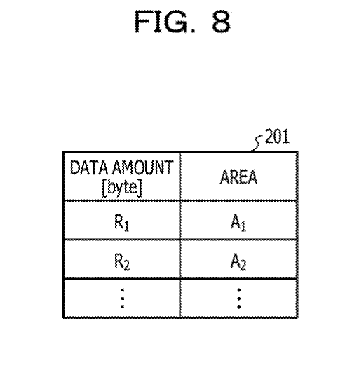

FIG. 8 illustrates a configuration example of the image information storing unit. As illustrated in FIG. 8, the data amount and the area of each piece of updated image information that is received are stored in the image information storing unit 201.

Subsequently, the client receiving unit 21 calculates an estimated value of the usable bandwidth based on the data amount of this updated image information and the transfer time (time from transmission to reception) of this updated image information (S403). This estimated value is stored in the usable bandwidth storing unit 202.

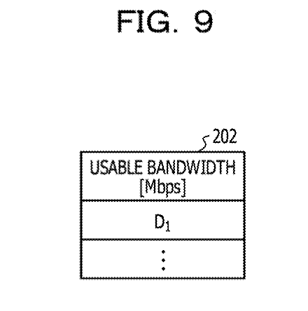

FIG. 9 illustrates a configuration example of the usable bandwidth storing unit. As illustrated in FIG. 9, the usable bandwidth [Mbps] that is calculated last is stored in the usable bandwidth storing unit 202.

Subsequently, the image information decompressing unit 22 decompresses the received updated image information and thereby restores updated image information this is compressed thus far (S404). At this time, the image information decompressing unit 22 measures the processing time it takes to decompress data of unit data amount. Subsequently, the image information decompressing unit 22 stores the measured processing time in the processing capability storing unit 203 (S405).

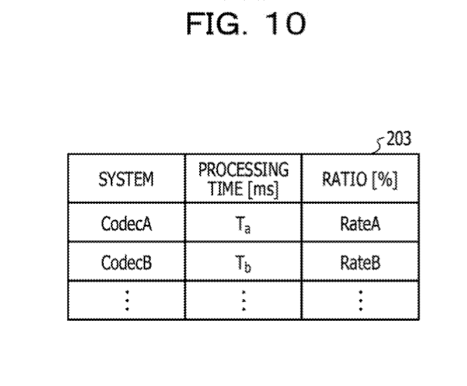

FIG. 10 illustrates a configuration example of the processing capability storing unit. As illustrated in FIG. 10, in the processing capability storing unit 203, the processing time [ms] per unit data amount and the ratio [%] are stored regarding each compression system or coding system (hereinafter, referred to simply as “system”). For example, there is the case in which systems different by partial region are applied to an updated region relating to one piece of updated image information. Therefore, the image information decompressing unit 22 measures the processing time per unit data amount regarding each system and stores the measurement result in the processing capability storing unit 203. Furthermore, the image information decompressing unit 22 stores the ratio of the partial region to which a respective one of the systems is applied in the updated region (area of the partial region÷area of the updated region) in the column of the ratio in the processing capability storing unit 203. The values stored in the processing capability storing unit 203 may be only the latest values or may be average values. If average values are employed, the history of the measurement result may be stored.

Subsequently, the received image rendering unit 23 writes the decompressed updated image information to the rendering buffer 204 (S406). Next, the received image rendering unit 23 calculates the number of times of writing to the rendering buffer 204 per one second (rendering frame rate) based on the elapsed time from the clock time when the updated image information received at the previous time is written to the rendering buffer 204 to the clock time when the updated image information received this time is written to the rendering buffer 204 (S407). The calculation result is stored in the rendering frame rate storing unit 205.

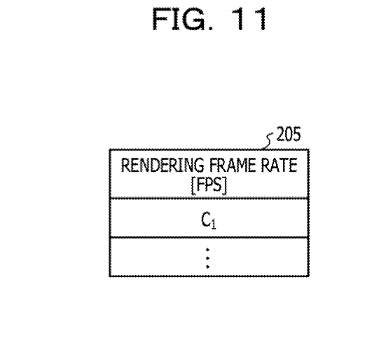

FIG. 11 illustrates a configuration example of the rendering frame rate storing unit. As illustrated in FIG. 11, the calculated rendering frame rate [FPS] is stored in the rendering frame rate storing unit 205. It may be said that the rendering frame rate is the actual performance value of the smoothness of display of the virtual desktop screen.

Because the updated image information is image information corresponding to update in the virtual desktop screen, there is a possibility that the data size of the updated image information is substantially inconstant. In such a case, for example, the history of the clock time of writing to the rendering buffer 204 may be stored in the rendering frame rate storing unit 205 and the rendering frame rate may be calculated based on the average value of the interval of the writing clock time represented by this history.

Subsequently, the screen display unit 24 outputs the contents of the rendering buffer 204 to the display device (S408).

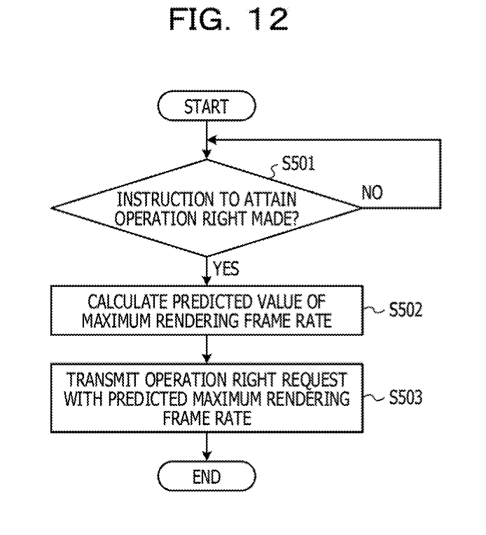

FIG. 12 is a flowchart for explaining one example of a processing procedure carried out by the client terminal at the time of transmission of an operation right request in the first embodiment.

When an instruction to attain the operation right is input by a user (S501; YES), the maximum rendering frame rate predicting unit 25 calculates a predicted value of the maximum rendering frame rate based on the values stored in the image information storing unit 201, the values stored in the processing capability storing unit 203, and the value stored in the usable bandwidth storing unit 202 (S502). Details of the calculation method of this predicted value will be described later.

Subsequently, the operation right request transmitting unit 27 transmits an operation right request including this predicted value and the terminal ID of the client terminal 20 to the server device 10 through the client transmitting unit 28 (S503).

Subsequently, one example of the calculation method of the predicated value of the maximum rendering frame rate will be described. Here, suppose that the usable bandwidth stored in the usable bandwidth storing unit 202 is D₁ [Mbps]. Furthermore, suppose that, as represented in FIG. 10, the ratio of application of a system CodecA in an updated region is RateA [%] and the ratio of application of a system CodecB in the updated region is RateB [%] (0<RateA <100, 0<RateB <100).

In this case, the processing time T [ms] of the updated image information per unit data amount (for example, U [pixels]) is calculated as follows.

T=Ta×RateA/100+Tb×RateB/100

For example, the total value obtained by weighting the processing time of each system by the ratio of application is deemed as the processing time T.

Furthermore, suppose that the average amount of received data per one frame (updated image information received in one time of reception) is R [byte] and the area of the updated region per one frame is A [pixels].

In this case, the processing time t [ms] per one frame is represented as follows.

t=((R×8)/(D₁×1000))+(A/U)×T

The values of R and A can be obtained through reference to the image information storing unit 201.

From the above, the maximum rendering frame rate [FPS] is represented by a reciprocal as follows.

$$\frac{1000}{t} = \frac{1000}{\frac{R 8}{{D}_{1} 1000} + \frac{A}{U} T}$$

For example, it is conceivable that there is the case in which the value of the maximum rendering frame rate is larger than the transmission frame rate of the server device 10 when the transmission frame rate is not very high and there is a margin in the communication environment and the processing capability on the side of the client terminal 20.

If the rendering frame rate is equal to or lower than the transmission frame rate, the rendering frame rate may be deemed as the maximum rendering frame rate directly. This is because, in such a situation, rendering of the virtual desktop screen will be carried out at the upper limit of the performance of the client terminal 20. In this case, the client terminal 20 may estimate the transmission frame rate based on the interval of reception of the updated image information by the client receiving unit 21.

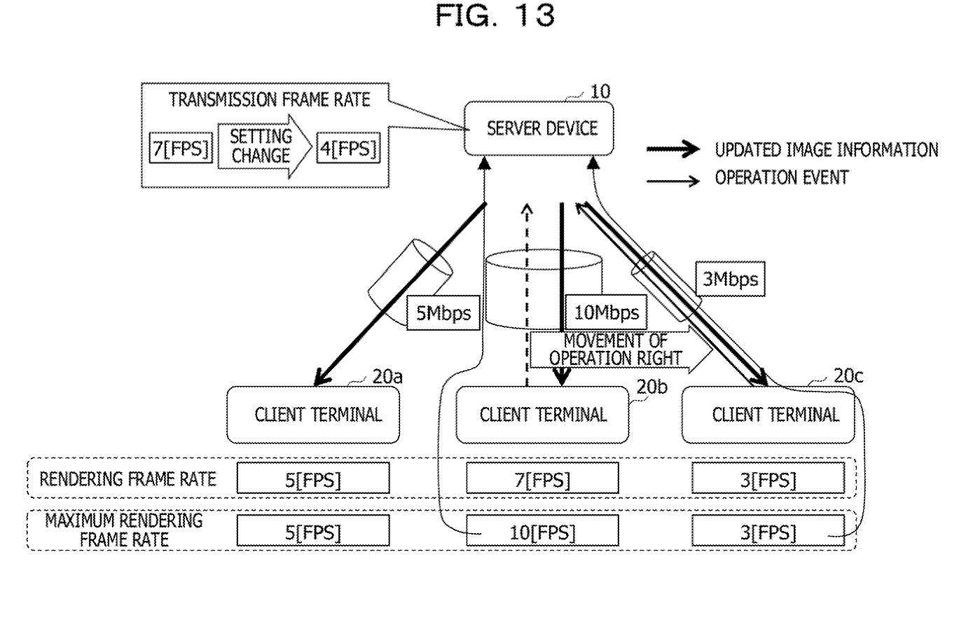

Subsequently, one example of the first embodiment will be described. FIG. 13 is a diagram for explaining the one example of the first embodiment. In FIG. 13, the state in which the virtual desktop screen is shared by the client terminal 20a, the client terminal 20b, and the client terminal 20c is illustrated. The rendering frame rates of the client terminals 20a, 20b, and 20c are 5 [FPS], 7 [FPS], and 3 [FPS], respectively. Furthermore, the usable bandwidths of the client terminals 20a, 20b, and 20c are 5 [Mbps], 10 [Mbps], and 3 [Mbps], respectively.

Suppose that originally the client terminal 20b includes the operation right and the transmission frame rate at the time is 7 [FPS]. Suppose that the maximum rendering frame rates of the client terminals 20a, 20b, and 20c are 5 [FPS], 10 [FPS], and 3 [FPS], respectively. For example, the client terminal 20b is in the state of including a margin with respect to the transmission frame rate.

Here, if the operation right is moved from the client terminal 20b to the client terminal 20c, the maximum rendering frame rates that are compared are 10 [FPS] of the movement origin and 3 [FPS] of the movement destination. Because the maximum rendering frame rate is lower in the movement destination, the transmission frame rate is set to 3+1=4 [FPS]. If the operation right moves from the client terminal 20c to the client terminal 20b, the transmission frame rate is set to 10×0.7=7 [FPS].

Here, description will be made concerning difference between the case in which the rendering frame rate of the movement destination of the operation right is employed as the transmission frame rate directly and the case in which the first embodiment is applied.

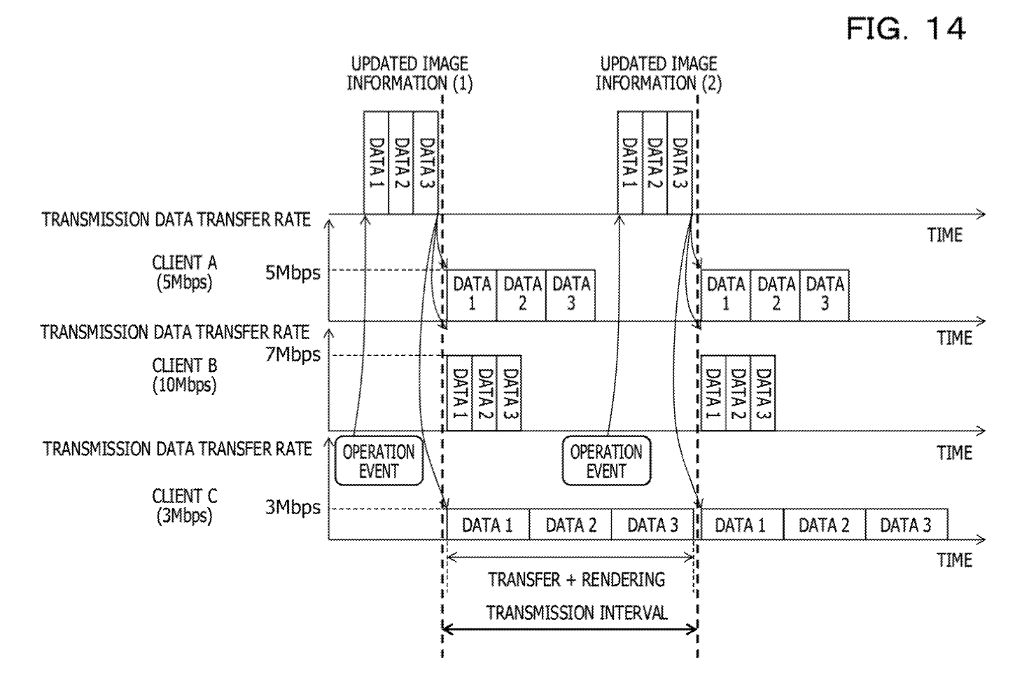

FIG. 14 illustrates the reception timing of updated image information and so forth in each client terminal in the case in which the rendering frame rate of the movement destination of the operation right is employed as the transmission frame rate.

In FIG. 14, the ordinate axis indicates the transmission data transfer rate regarding each client terminal 20 and the abscissa axis indicates the time. Furthermore, the uppermost row indicates the transmission timing of the updated image information from the server device 10. In each client terminal 20, the width of rectangles that represent data 1 to data 3 is the time taken to transfer and render these pieces of data. The height of these rectangles is the transmission data transfer rate of the client terminal 20. In FIG. 14, client A, client B, and client C correspond to the client terminal 20a, the client terminal 20b, and the client terminal 20c, respectively, in FIG. 13.

In FIG. 14, the transmission frame rate is set to correspond with the rendering frame rate of client C (3 [FPS]). For example, the transmission interval of the updated image information is set to correspond with the time taken to transfer and render data 1 to data 3 in client C. Therefore, in client A and client B, the interval from reception of data 3 of updated image information (1) to reception of data 1 of updated image information (2) is long. This indicates that the smoothness of display of the virtual desktop screen is lowered.

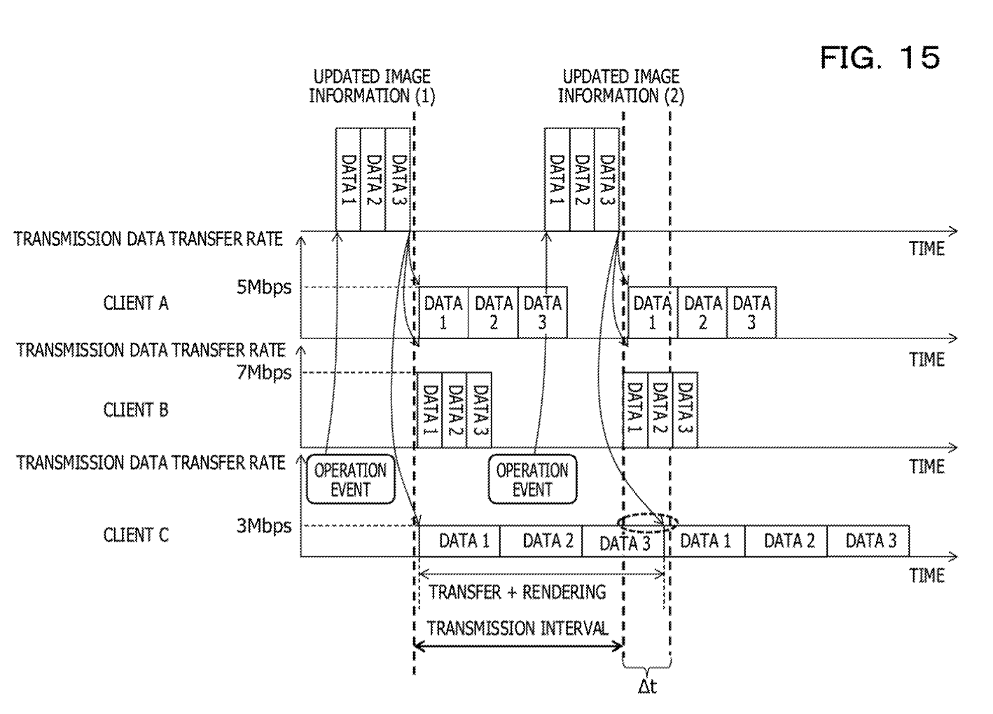

On the other hand, FIG. 15 illustrates the reception timing of updated image information and so forth in each client terminal in the case in which the first embodiment is applied. How to see FIG. 15 is the same as FIG. 14.

In FIG. 15, an example in which the transmission frame rate is set to the maximum rendering frame rate of client C+1=4 [FPS] is illustrated. In this case, the transmission interval becomes shorter by Δt than in FIG. 14. Therefore, each client terminal 20 receives updated image information (2) at a timing earlier by Δt than in FIG. 14. As a result, in client A and client B, the smoothness of display of the virtual desktop screen is improved compared with FIG. 14.

In FIG. 15, in client C, reception of updated image information (2) is started before the completion of processing of data 3 of updated image information (1). How client C behaves in such a state depends on the OS client C and implementation of a client program of the virtual desktop and so forth.

As described above, according to the first embodiment, the transmission frame rate is decided based on comparison between the smoothness of display of the virtual desktop screen in the movement origin of the operation right and the smoothness of display in the movement destination of the operation right. Therefore, the virtual desktop screen is transmitted at the transmission interval according to the status of the plural client terminals 20 that share the virtual desktop screen via a network.

Next, a second embodiment will be described. In the second embodiment, a different point from the first embodiment will be described. In the second embodiment, points that are not particularly mentioned may be the like as the first embodiment. In the second embodiment, description will be made concerning an example in which the lowering of the smoothness of display is suppressed by adjusting the image quality of updated image information without changing the transmission frame rate if the transmission frame rate calculated in association with the movement of the operation right is lower than a threshold α.

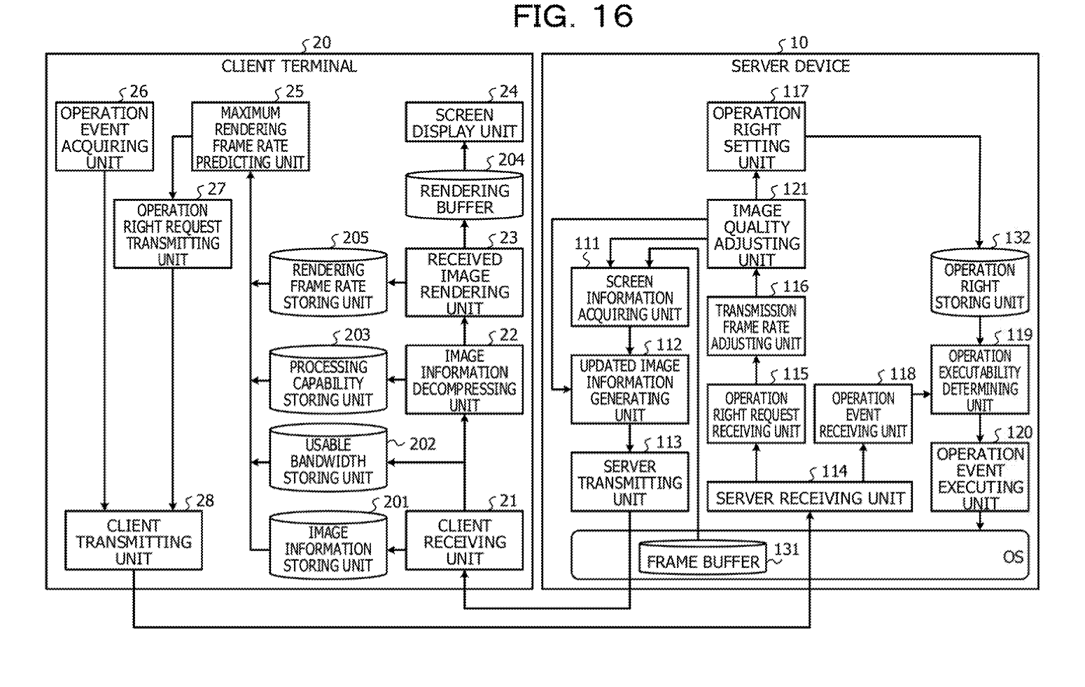

FIG. 16 illustrates a functional configuration example of a virtual desktop infrastructure in the second embodiment. The same part as FIG. 3 is given the same numeral in FIG. 16 and description thereof is omitted. In FIG. 16, a server device 10 further includes an image quality adjusting unit 121. The image quality adjusting unit 121 lowers the image quality of updated image information if the transmission frame rate calculated in association with the movement of the operation right is lower than the threshold α. The image quality adjusting unit 121 is implemented by processing which one or more programs installed on the server device 10 cause the CPU 104 to execute.

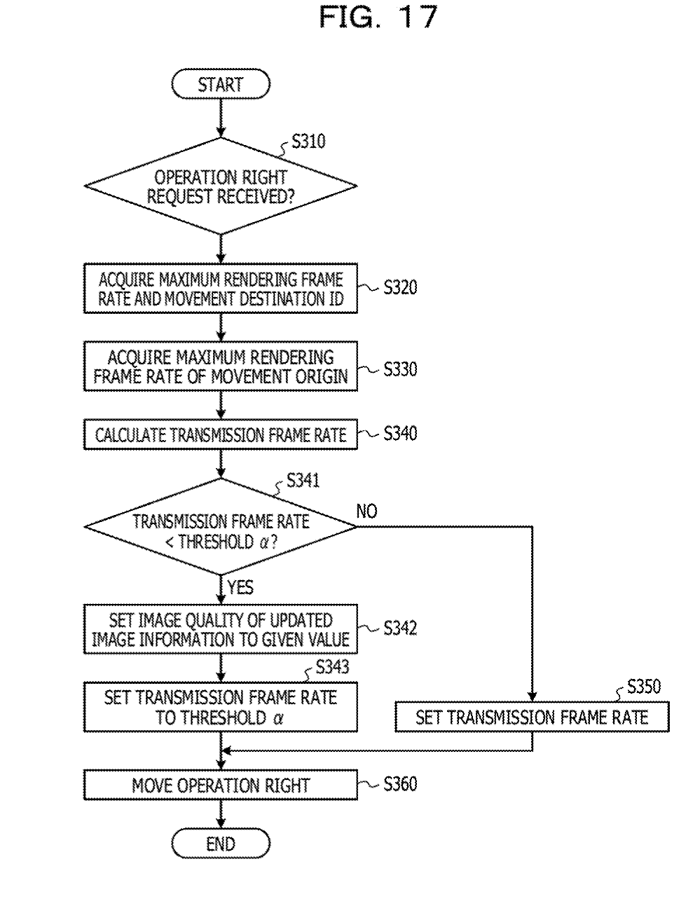

FIG. 17 is a flowchart for explaining one example of a processing procedure carried out by the server device at the time of movement of the operation right in the second embodiment. The same step as FIG. 6 is given the same step number in FIG. 17 and description thereof is omitted.

Subsequently to the step S340, the image quality adjusting unit 121 determines whether or not the calculated transmission frame rate is lower than the threshold α (for example, 5 [FPS]) (S341). If the calculated transmission frame rate is equal to or higher than the threshold α (S341; NO), the step S350 and the subsequent steps are carried out similarly to the first embodiment.

On the other hand, if the calculated transmission frame rate is lower than the threshold α (S341; YES), the image quality adjusting unit 121 sets a given value as the image quality of updated image information in the updated image information generating unit 112 (S342). For example, a value with which the image quality becomes 50% of the normal image quality is set as the given value. When generating updated image information from then on, the updated image information generating unit 112 generates the updated image information with the image quality according to the set given value. Here, the image quality is a concept that represents the degree of omission of information in coding. The adjustment of the image quality can be implemented through change in the value of a parameter of the coding, change of the coding system, and so forth. Therefore, this given value may be the value of the parameter of the coding or may be a value that represents the coding system.

Subsequently, the image quality adjusting unit 121 sets the threshold α as the transmission frame rate in the screen information acquiring unit 111 (S343). For example, the calculated transmission frame rate is deemed invalid.

For example, suppose that the threshold α=5 [FPS] in a case like that illustrated in FIG. 13. In this case, the transmission frame rate decided when the operation right moves to the client terminal 20c in the second embodiment is the threshold α (5 [FPS]). This transmission frame rate is higher than the upper limit of the processing capability (maximum rendering frame rate) of the client terminal 20c by 2 [FPS]. Thus, the processing load of the client terminal 20c increases and as a result possibly the smoothness of display in the client terminal 20c is lowered. Then, in the second embodiment, the lowering of the image quality of updated image information is intended. Due to the lowering of the image quality of updated image information, increase in the transfer time of the updated image information and the processing load of the client terminal 20c is suppressed even when the transmission frame rate becomes higher. Meanwhile, because falling of the transmission frame rate below the threshold α is avoided, the lowering of the smoothness of display in the client terminal 20a and the client terminal 20b is suppressed.

The threshold α may be allowed to vary according to the rendering frame rates of the respective client terminals 20. Furthermore, the setting value of the image quality when the transmission frame rate is lower than the threshold α may also be dynamically changed instead of being set to a fixed value.

Next, a third embodiment will be described. In the third embodiment, a different point from the first embodiment will be described. In the third embodiment, points that are not particularly mentioned may be the like as the first embodiment. In the third embodiment, description will be made concerning an example in which the lowering of the smoothness of display is suppressed by stopping the movement of the operation right if the transmission frame rate calculated in association with the movement of the operation right is lower than a threshold β. The threshold β may be the same as the threshold α.

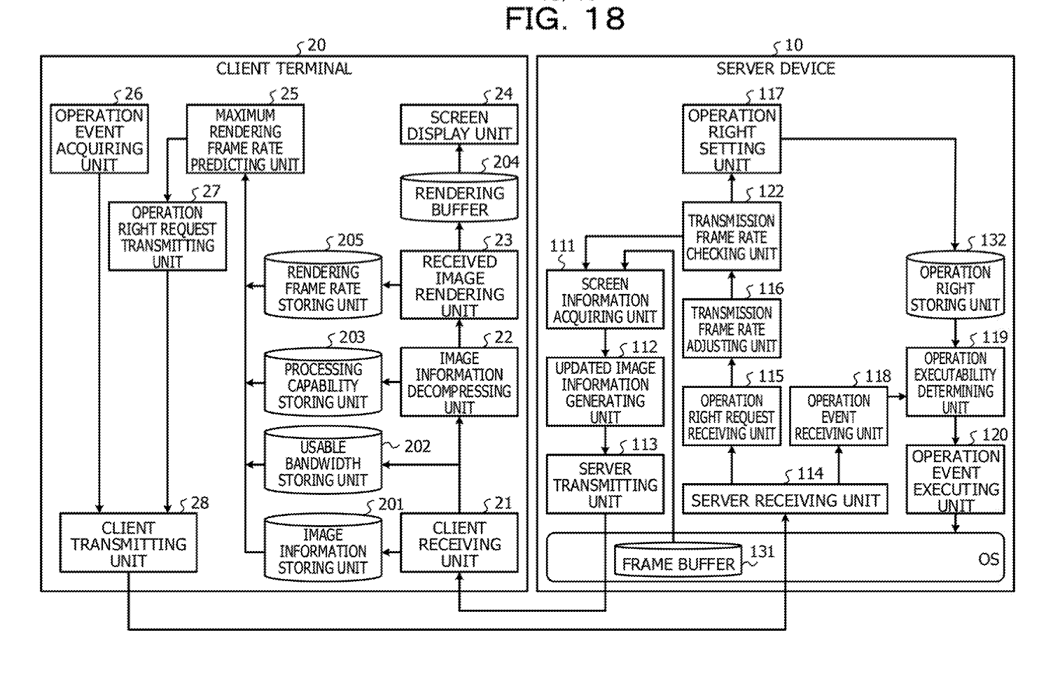

FIG. 18 illustrates a functional configuration example of a virtual desktop infrastructure in the third embodiment. The same part as FIG. 3 is given the same numeral in FIG. 18 and description thereof is omitted. In FIG. 18, a server device 10 further includes transmission frame rate checking unit 122 stops the movement of the operation right if the transmission frame rate calculated in association with the movement of the operation right is lower than the threshold β. The transmission frame rate checking unit 122 is implemented by execution of one or more programs installed on the server device 10 by the CPU 104.

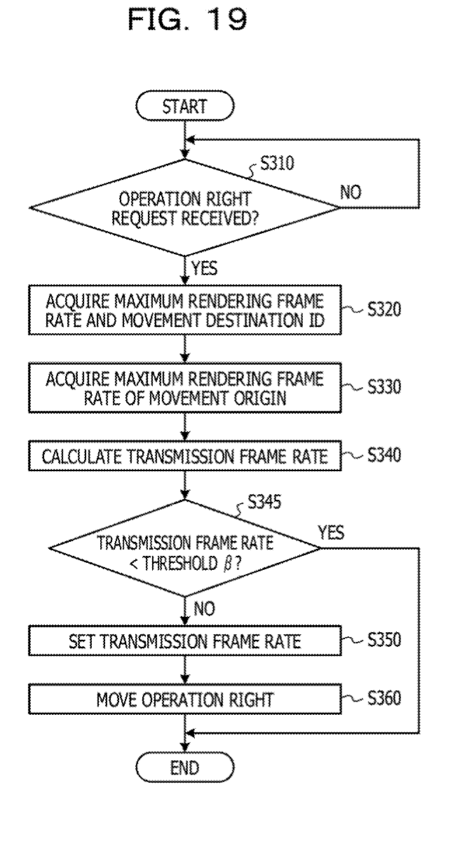

FIG. 19 is a flowchart for explaining one example of a processing procedure carried out by the server device at the time of movement of the operation right in the third embodiment. The same step as FIG. 6 is given the same step number in FIG. 19 and description thereof is omitted.

Subsequently to the step S340, the transmission frame rate checking unit 122 determines whether or not the calculated transmission frame rate is lower than the threshold β (for example, 5 [FPS]) (S345). If the calculated transmission frame rate is equal to or higher than the threshold β (S345; NO), the step S350 and the subsequent steps are carried out similarly to the first embodiment.

On the other hand, if the calculated transmission frame rate is lower than the threshold β (S345; YES), the transmission frame rate checking unit 122 causes avoidance of the execution of the step S350 and the subsequent step. As a result, the operation right is not moved and change in the transmission frame rate is not made.

For example, in a case like that illustrated in FIG. 13, the movement of the operation right to the client terminal 20c is avoided. As a result, the situation in which the smoothness of display in the other client terminals 20 is lowered in such a manner as to be dragged by the client terminal 20c is avoided.

The threshold β may be allowed to vary according to the rendering frame rates of the respective client terminals 20.

Furthermore, the third embodiment and the second embodiment may be combined. In this case, threshold β<threshold α may be satisfied.

In the above-described respective embodiments, the server device 10 is one example of a screen transmitting device. The server transmitting unit 113 is one example of a transmitting unit. The operation event executing unit 120 is one example of a reflecting unit. The transmission frame rate adjusting unit 116 is one example of a deciding unit. The image quality adjusting unit 121 is one example of an adjusting unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method comprising:
transmitting a screen shared by a plurality of apparatuses coupled through a network to the plurality of apparatuses at a given interval;
updating the screen based on operation information when receiving the operation information regarding the screen from a first apparatus which an operation right regarding the screen is given among the plurality of apparatuses; and
determining, by a processor, the given interval based on comparison between a first index value that represents smoothness of display of the screen in the first apparatus and a second index value that represents smoothness of display of the screen in a second apparatus among the plurality of apparatuses when the operation right is moved from the first apparatus to the second apparatus.

2. The method according to claim 1, wherein
when the second index value indicates that the display is smoother than the first index value, the determining determines the given interval in such a manner that smoothness of the display becomes lower than smoothness relating to the second index value.

3. The method according to claim 1, wherein
when the first index value indicates that the display is smoother than the second index value, the determining determines the given interval in such a manner that smoothness of the display becomes higher than smoothness relating to the second index value.

4. The method according to claim 1, wherein
the first index value is calculated based on a bandwidth that is usable by the first apparatus regarding the network and a time taken to execute processing of displaying the screen in the first apparatus.

5. The method according to claim 1, further comprising:
when the given interval determined by the determining is lower than a threshold, as the given interval determined by the determining is invalid, lowering image quality of the screen to be transmitted by the transmitting.

6. An apparatus comprising:
a memory; and
a processor coupled to the memory and configured to:
transmit a screen shared by a plurality of apparatuses coupled through a network to the plurality of apparatuses at a given interval,
update the screen based on operation information when receiving the operation information regarding the screen from a first apparatus which an operation right regarding the screen is given among the plurality of apparatuses, and
determine the given interval based on comparison between a first index value that represents smoothness of display of the screen in the first apparatus and a second index value that represents smoothness of display of the screen in a second apparatus among the plurality of apparatuses when the operation right is moved from the first apparatus to the second apparatus.

7. The apparatus according to claim 6, wherein the processor is configured to:
when the second index value indicates that the display is smoother than the first index value, determine the given interval in such a manner that smoothness of the display becomes lower than smoothness relating to the second index value.

8. The apparatus according to claim 6, wherein the processor is configured to:
when the first index value indicates that the display is smoother than the second index value, determine the given interval in such a manner that smoothness of the display becomes higher than smoothness relating to the second index value.

9. The apparatus according to claim 6, wherein
the first index value is calculated based on a bandwidth that is usable by the first apparatus regarding the network and a time taken to execute processing of displaying the screen in the first apparatus.

10. The apparatus according to claim 6, wherein the processor is configured to:
when the given interval determined is lower than a threshold, as the given interval determined is invalid, lower image quality of the screen to be transmitted.

11. A non-transitory storage medium storing a program that causes a computer to execute a process, the process comprising:
transmitting a screen shared by a plurality of apparatuses coupled through a network to the plurality of apparatuses at a given interval;
updating the screen based on operation information when receiving the operation information regarding the screen from a first apparatus which an operation right regarding the screen is given among the plurality of apparatuses; and
determining the given interval based on comparison between a first index value that represents smoothness of display of the screen in the first apparatus and a second index value that represents smoothness of display of the screen in a second apparatus among the plurality of apparatuses when the operation right is moved from the first apparatus to the second apparatus.

12. The storage medium according to claim 11, wherein
when the second index value indicates that the display is smoother than the first index value, the determining determines the given interval in such a manner that smoothness of the display becomes lower than smoothness relating to the second index value.

13. The storage medium according to claim 11, wherein
when the first index value indicates that the display is smoother than the second index value, the determining determines the given interval in such a manner that smoothness of the display becomes higher than smoothness relating to the second index value.

14. The storage medium according to claim 11, wherein
the first index value is calculated based on a bandwidth that is usable by the first apparatus regarding the network and a time taken to execute processing of displaying the screen in the first apparatus.

15. The storage medium according to claim 11, wherein the process further comprises:
when the given interval determined by the determining is lower than a threshold, as the given interval determined by the determining is invalid, lowering image quality of the screen to be transmitted by the transmitting.
